(19) United States
(12) Patent Application Publication
(10) Pub. No.: US 2015/0358478 A1
(43) Pub. Date: Dec. 10, 2015

(54) SYSTEMS AND METHODS FOR IDENTIFYING AND UPDATING SERVICE ACCOUNT INFORMATION

(71) Applicant: VONAGE NETWORK LLC, Holmdel, NJ (US)

(72) Inventors: Chen Arazi, Morganville, NJ (US); Val Ornoy, San Francisco, CA (US)

(21) Appl. No.: 14/300,905

(22) Filed: Jun. 10, 2014

(51) Int. Cl. H04M 15/00; H04W 4/14

(52) U.S. Cl. CPC H04M 15/61; H04M 15/56; H04W 4/14

(57) ABSTRACT

Systems and methods for identifying and updating service account information on a service provider system are provided herein. In some embodiments, a method for identifying and updating service account information on a service provider system may include receiving a first request to register a user account from a mobile app installed on a user device, wherein the first request includes a unique communication identifier, sending a communication message directed to the unique communication identifier including a uniform resource locator (URL) address of a website, receiving, via the website, payment information, an indication of the user account, and an indication of a purchased amount, and updating account balance information associated with the user account based on the indication of the purchased amount.

### BACKGROUND

1. Field

Embodiments of the present invention relate generally to systems and methods for identifying and updating service account information, and more specifically to systems and methods for identifying and adding usage credits to a user's service account.

2. Description of the Related Art

Today, a user wishing to obtain services from a service provider may establish an account with the service provider. For example, a user wishing to obtain telephony services may establish an account with a telephony service provider and may, for a fee, use those telephony services.

Some services providers have developed over-the-top (OTT) applications (or apps) which can be downloaded and installed onto a user's device. The OTT applications are typically downloaded from app distribution platforms such as Google Play™ or Apple® App Store^{SM}. An OTT application provides an interface that facilitates the user's usage of the services provided by the service provider. Once the user has purchased usage credits (e.g., virtual monetary credits, minutes of use, a service plan, or the like) from the service provider, the application can be used to access the services provided by the service provider. For example, a user that downloads a voice over internet protocol (VoIP) telephony app associated with a VoIP service provider can purchase credits/minutes, and can use those credits/minutes to make international telephone calls using the VoIP app.

Typically, however, if usage credits, or any other type of products, are purchased or otherwise obtained from within the OTT application, otherwise known as in-app purchases, the app distribution platform or other third party service associated with app distribution platform retains a percentage of the monies collected for all in-app purchases in the form of a transaction fee. That is, the app distribution platform that facilitates the in-app purchase takes a share of the funds collected (e.g., usually in the range of 30% or so) with the rest going to the app developer/service provider (e.g., 70%).

In view of the foregoing, there exists a need in the art for improved methods and systems for providing service providers the ability to sell usage credits or other products/services to its users, and to associate the usage credits or other products/services sold with the user's service account without incurring the usual transaction fees.

### SUMMARY

Systems and methods for identifying and updating service account information on a service provider system are provided herein. In some embodiments, a method for identifying and updating service account information on a service provider system may include receiving a first request to register a user account from a mobile app installed on a user device, wherein the first request includes a unique communication identifier, sending a communication message directed to the unique communication identifier including a uniform resource locator (URL) address of a website, receiving, via the website, payment information, an indication of the user account, and an indication of a purchased amount, and updating account balance information associated with the user account based on the indication of the purchased amount.

In some embodiments, a method for registering a mobile app and obtaining mobile app credits may include downloading the mobile app from a first distribution entity, sending a first request to register a user account associated with the mobile app to a second entity, wherein the request includes a unique communication identifier, receiving, responsive to the first request sent, a communication message directed to the unique communication identifier including a uniform resource locator (URL) address of a website of the second entity, displaying the website in a browser application responsive to receiving a selection of the URL address, and submitting, via the browser, payment information and the unique communication identifier to the website to associate mobile app credits with the user account for use with the mobile app.

In some embodiments, a system for identifying and updating service account information on a service provider system may include a user account database that stores user account information, an account services system including at least one processor comprising: a registration module configured to receive a first request to register a user account from a mobile app installed on a user device, wherein the first request includes a unique communication identifier; and an account balance monitor module configured to send a communication message directed to the unique communication identifier including a uniform resource locator (URL) address of a secure transaction processing system website of the service provider system; and the secure transaction processing system including website configured to: receive payment information and the unique communication identifier via the website for a purchase of mobile app credits for use with the mobile app; and update account balance information in the user account database associated with the unique communication identifier based on the purchase of mobile app credits.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a system for identifying and updating service account information on a service provider system, according to one or more embodiments;

FIG. 3 depicts a method for identifying and updating service account information on a service provider system, according to one or more embodiments;

FIG. 4 depicts a computer system that can be utilized in various embodiments of the present invention, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention relate generally to improved methods and systems for providing service providers the ability to sell usage credits or other products/services to its users, and to associate the usage credits or other products/services sold with the user's service account without incurring the usual transaction fees.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

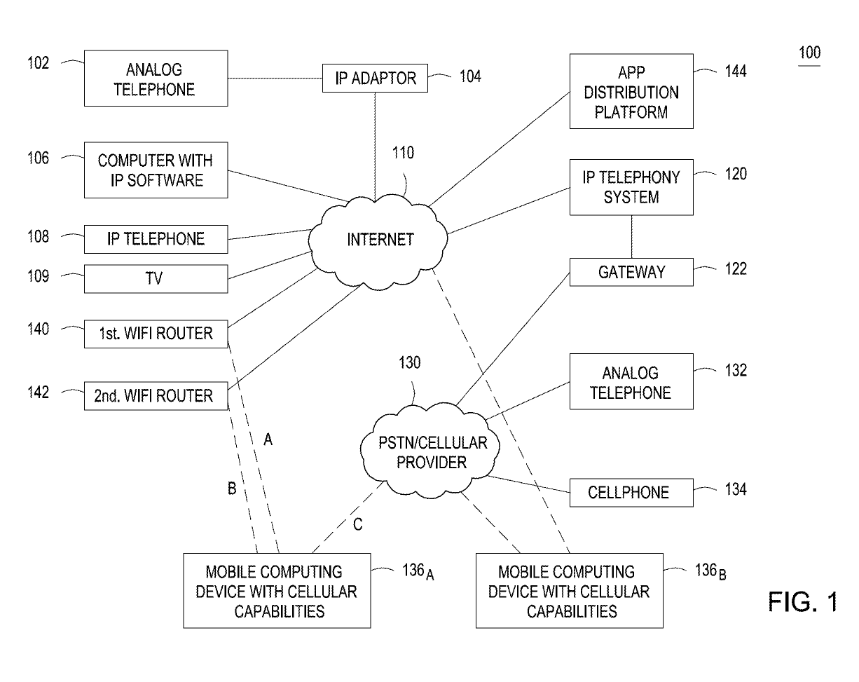

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136A (e.g., a smartphone) is capable of establishing a first wireless data connection A with a first wireless access point 140, such as a WiFi or WiMax router. The first wireless access point 140 is coupled to the Internet 110. Thus, the mobile computing device 136A can establish a VOIP telephone call with the IP telephony system 120 via a path through the Internet 110 and the first wireless access point 140.

FIG. 1 also illustrates that the mobile computing device 136A can establish a second wireless data connection B with a second wireless access point 142 that is also coupled to the Internet 110. Further, the mobile computing device 136A can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136A could also establish a VoIP telephone call with the IP telephony system 120 via the second wireless connection B or the third wireless connection C.

Although not illustrated in FIG. 1, the mobile computing device 136A may be capable of establishing a wireless data connection to a data network, such as the Internet 110, via alternate means. For example, the mobile computing device 136A might link to some other type of wireless interface using an alternate communication protocol, such as the WIMAX standard. In the embodiments described above, a device may act as a mobile telephony device once it is configured with appropriate application software that may be downloaded from an app distribution platform 144. For example, mobile computing device 136A may download a VOIP mobile app from app distribution platform 144 and install the VOIP mobile app on mobile computing device 136A.

Similarly, mobile computing device with cellular capabilities 136B may also be coupled to internet 110 and/or cellular service provider 130. In some embodiments, mobile computing device 136B may be connected to internet 110 via a WIFI or WIMAX connection, and the like, and can also establish a VOIP telephone calls with the IP telephony system 120 similar to mobile computing device 136A. In embodiments of the present invention, communications environment 100 may be used to establish voice based or data based telecommunications sessions between mobile computing device 136A and mobile computing device 136B, depending on various criteria associated with each of the mobile computing devices, as will be described below in more detail. In some exemplary embodiments described below, mobile computing devices 136A and 136B are on different service provider networks and communications between mobile computing devices 136A and 136B are “off-net” communications. When mobile computing devices 136A and 136B are on the same service provider network, communications between mobile computing devices 136A and 136B are considered “on-net” communications.

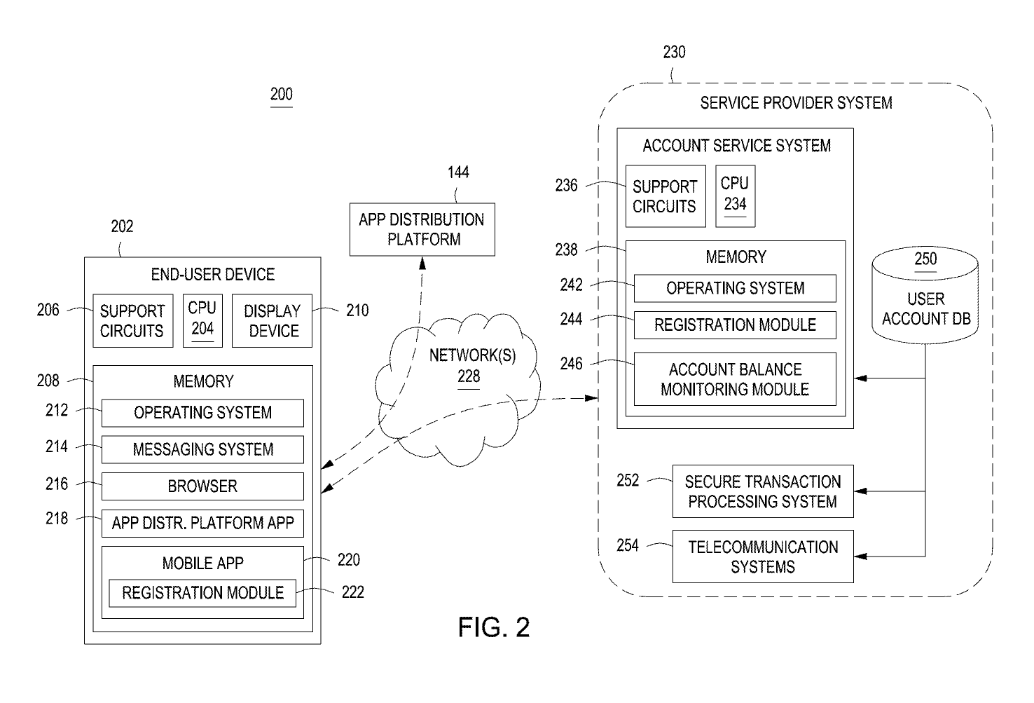

FIG. 2 depicts a block diagram of a system 200 for identifying and updating service account information, according to one or more embodiments. The system 200 comprises end-user device 202 and service provider system 230 communicatively coupled via networks 228. In some embodiments, end-user device 202 may be one of mobile computing devices 136A or 136B, computer 106, TV 109 or the like, and service provider system 230 may be IP telephony system 120 as described above in FIG. 1.

The end-user device 202 comprises a Central Processing Unit (CPU) 204, support circuits 206, memory 208, and a display device 210. The CPU 204 may comprise one or more commercially available microprocessors or microcontrollers that facilitate data processing and storage. The various support circuits 206 facilitate the operation of the CPU 204 and include one or more clock circuits, power supplies, cache, input/output device and circuits, and the like. The memory 208 comprises at least one of Read Only Memory (ROM), Random Access Memory (RAM), disk drive storage, optical storage, removable storage and/or the like. In some embodiments, the memory 208 comprises an operating system 212, messaging system 214, browser 216, an app distribution platform app 218, and a mobile app 220.

The operating system (OS) 212 generally manages various computer resources (e.g., network resources, file processors, and/or the like). The operating system 212 is configured to execute operations on one or more hardware and/or software modules, such as Network Interface Cards (NICs), hard disks, virtualization layers, firewalls and/or the like. Examples of the operating system 212 may include, but are not limited to, various versions of LINUX, MAC OSX, BSD, UNIX, MICROSOFT WINDOWS, 10S, ANDROID and the like. In some embodiments, operating system 212 may include an application programming interface (API) which can be used to access and user device information and features (such as, for example, by mobile app 220).

The messaging system 214 maybe any communication application is able to receive and display messages to a user of end-user device 202. For example, in some embodiments, the messaging system 214 may be an email application, a Short Message Service (SMS) or Multimedia Message Service (MMS) messaging system, and instant messaging system, and the like. The browser 216 may be any browser supported by the operating system 212, such as for example, SAFARI, CHROME, FIREFOX, INTERNET EXPLORER, and the like. The app distribution platform app 218 may be any app that provides an interface to app distribution platforms such as for example, Google PIay™ or Apple® App Store^{SM}. In some embodiments, the app distribution platforms may be accessed via browser 216 to locate and download apps for installation on device 202.

In some embodiments, the mobile app 220 is a VoIP app that provides over-the-top (OTT) VoIP telephony services to an end-user. In some embodiments, OTT content describes broadband delivery of media/data/services without a traditional cellular service provider (e.g., PSTN provider 130) being involved in the control or distribution of the content itself. The provider may be aware of the contents of the IP packets but is not responsible for, nor able to control, the viewing abilities, copyrights, and/or other redistribution of the content. In embodiments consistent with the present application, an end-user may download the mobile app 220 via the app distribution system 144, and install the mobile app 220 on their device.

In some embodiments mobile app 220 may include a registration module 222 that initiates a registration procedure to register a user account associated with the mobile app 220 with service provider 230 that is providing the services used by mobile app 220. The registration module 222 may automatically initiate upon installation of the mobile app 220 on end-user device 202. In some embodiments, the registration module 222 may request information from a user of end-user device 202, and or may obtain information directly from the device (e.g., a phone number, contact lists, device specific information, etc.) to register the user account associated with the mobile app 220 for use with the service provider system 230. In some embodiments, the registration module 222 may encrypt all or a portion of the information sent to service provider system 230 to register mobile app 220, or otherwise transmit the information in a secure format.

The networks 228 comprise one or more communication systems that connect computers by wire, cable, fiber optic and/or wireless link facilitated by various types of well-known network elements, such as hubs, switches, routers, and the like. The networks 228 may include an Internet Protocol (IP) network (such as internet 110 of FIG. 1), a public switched telephone network (PSTN) (such as the PSTN network of PSTN provider 130 of FIG. 1), or other mobile communication networks, and may employ various well-known protocols to communicate information amongst the network resources.

In some embodiments, service provider system 230 may be a VoIP service provider or a mobile app developer. Service provider system 230 may include an account services system 232 that may be used, for example, to create user accounts, register mobile apps downloaded and installed on end-user devices, and monitor user account balances, among other functions. In some embodiments, account services system 232 may be an entity that provides registration/account management services to service provider system 230 by agreement. The account services system 232 comprises a Central Processing Unit (CPU) 234, support circuits 236, and memory 238. The CPU 234 may comprise one or more commercially available microprocessors or microcontrollers that facilitate data processing and storage. The various support circuits 236 facilitate the operation of the CPU 234 and include one or more clock circuits, power supplies, cache, input/output circuits, and the like. The memory 238 comprises at least one of Read Only Memory (ROM), Random Access Memory (RAM), disk drive storage, optical storage, removable storage and/or the like. In some embodiments, the memory 208 comprises an operating system 242, registration module 244, and an account balance monitoring module 246. The operating system (OS) 242 generally manages various computer resources (e.g., network resources, file processors, and/or the like). The operating system 242 is configured to execute operations on one or more hardware and/or software modules, such as Network Interface Cards (NICs), hard disks, virtualization layers, firewalls and/or the like. Examples of the operating system 242 may include, but are not limited to, various versions of LINUX, MAC OSX, BSD, UNIX, MICROSOFT WINDOWS, 10S, ANDROID and the like.

The registration module 244 may communicate with registration module 222 to register mobile app 220 with the service provider system 230. In some embodiments, the registration module may create a user account for the user of mobile app 220 based on the registration information. Registration module 244 may create and store the user account information in user account database 250. The service provider system 230 may have direct or indirect access to database 250. For example, database 250 may exist on the service provider system 230 (direct access), or be accessible through a third party network (indirect access). In some embodiments, a user of end-user device 202 may already have established an account with service provider system 230 prior to registering mobile app 220. In those embodiments registration module 244 may update the user account information in user account database 250 to indicate that mobile app 220 has been registered for that user.

The account balance monitoring module 246 will monitor the account balances of user accounts stored in user account database 250. Upon successful registration of mobile app 220 by the registration module 244, the account balance monitoring module 246 may automatically create and send a message to end-user device 202 that includes a link to a website where the user can purchase credits or other services at a discount. In some embodiments, the account balance monitoring module 246 will continually monitor the account balance of the user account associated with mobile app 220 and end-user device 202, and automatically generate and send a message to end-user device 202 when the user account balance falls below a predefined limit. In some embodiments, the low balance message will be sent periodically, and can be configured to be sent daily, weekly, monthly, or other time period. In embodiments where the user has as authorized automatic replenishment when the user account balance falls below a predefined monetary level, the account balance monitoring module 246 will facilitate the replenishment of the account balance to a specified amount and send the receipt of the transaction to end-user device 202 as appropriate. In some embodiments, the predefined low balance amounts and replenishment amounts may be set by the user via a mobile app 224 or via a web interface provided by account services system 232 to set/update the information and other user settings. In some embodiments, default low balance amounts and replenishment amounts may be used initially.

The service provider system 230 also includes a secure transaction processing system 252 and telecommunication systems 254 for providing telecommunication services to mobile app 220 in end-user device 202. The secure transaction processing system 252 facilitates the sales and secure payment processing of credits sold to users for use with mobile app 220. The secure transaction processing system 252 may access user account database 250 to update user account balances when purchases are made. Telecommunication systems 254 may access user account database 250 to check account balances before paid services are used, and to deduct from those account balances accordingly when paid services are used.

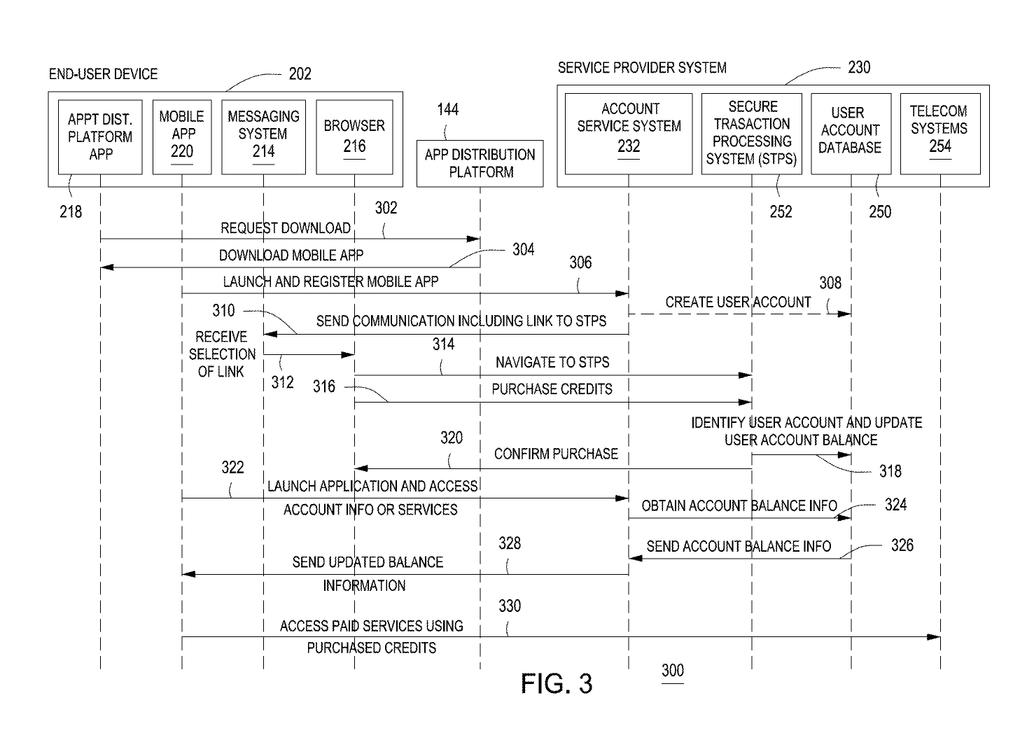

FIG. 3 depicts a diagram of a method 300 for identifying and updating service account information according to one or more embodiments. In embodiments consistent with FIG. 3, the end-user device 202 may already have app distribution platform app 218, messaging system 214, and browser 216 installed on the end-user device. The method 300 begins at 302 where a request to download mobile app 220 is sent to app distribution platform 144 from app distribution platform app 218. At 304, the mobile app 220 is downloaded from app distribution platform 144 and installed on end-user device 202.

At 306, mobile app 220 is launched and automatically begins a registration process. In some embodiments the registration process may be performed by registration module 222 of mobile app 220 and registration module 244 of account services system 232. During the registration process, the user may be asked to input a phone number, or other unique communication identifier, that will be sent to service provider system 230 for registration purposes. Other information may also be requested for verification/registration purposes. In some embodiments, the user may be asked to provide a communication preference (e.g., SMS, email, and the like) so that service provider system can communicate offers and other information related to mobile app 220 and the services provided by service provider system 230 to the user of device 202. In some embodiments, the required registration information (e.g., such as the phone number) will be automatically obtained from the device using application programming interface (API) calls to the operating system 212 by mobile app 220. During the registration process, mobile app 220 may communicate within the registration module 244 of account services system 232 of the service provider system 230 to provide the necessary information.

At 308, the registration module 244 of account services system 232 may optionally create a user account in user account database 250 based on the phone number, or other unique communication identifier, provided during the registration procedure. A unique account identifier that uniquely identifies the user's account is based on the phone number or unique communication identifier provided. In some embodiments, if a user account associated with the communication identifier provided exists, the account services system will update the user account to include the registration information provided by mobile app 220.

At 310, after a user account has been created/updated, the account balance monitoring module 246 may generate and send a communication message to end-user device 202 using the communication method specified during the registration process. In some embodiments, the communication message may include a link to a website (e.g., a uniform resource locator (URL) address) associated with service provider system 230 where the user can purchase, via browser 216, credits or other services at a discount. In some embodiments, the link included in the communication message may include URL variables or query strings that include some unique user information, such that when selected, a browser 216 on end-user device 202 will be directed to a website that already has some of the user's information populated. This pre-populated information may advantageously make it easier for the user to purchase credits by more accurately identifying and crediting the correct account. In some embodiments, the communication message may further include a promotional message indicating a discount for purchasing credits if done through a specified service or via a specified URL. In some embodiments, the website where the user can purchase may be hosted by a third party service provider (i.e., a Web hosting platform) that is under the direction and control of the service provider 230 and, thus, considered to be associated with service provider system 230.

In embodiments consistent with the present invention, the communication message may be an email message, an SMS/MMS message, or other type of message that could be sent outside of the mobile app 220 to be displayed and viewed by the user of end-user device 202. In some embodiments, the communication message sent may be viewed within a native messaging system 214 on end-user device 202 (i.e., not using mobile app 220). In other embodiments, the communication message sent may be viewed within a messaging feature of mobile app 220. Regardless of the format used, the selection of a link within the communication message that will open a browser (e.g., browser 216) to a specific website will be described below.

The communication messages sent by account balance monitoring module 246 may be triggered by the occurrence of various different events. In some embodiments, an initial communication message to end-user device 202 may be triggered upon completion of the registration process. That is, after a user has successfully registered with service provider system 230 via the mobile app 228, a communication message may be automatically sent to end-user device 202. In some embodiments, the account balance monitoring module 246 may periodically review the account balances of user accounts stored in user account database 250. Any account balance monitored by account balance monitoring module 246 that falls below a certain limit may trigger a communication message to be sent to the communication identifier associated with said account. In some embodiments, after a user finishes a call which requires the use of credits, the account balance monitoring module may automatically review a user's account balance and trigger a communication message if the user's account balance falls below a trigger amount set by the user.

At 312, a user of end-user device 202 may view the communication message sent and select the link embedded in the message. At 314, the selection of the link at 312 will cause browser 216 to navigate to the URL specified by the link. That is, selection of the selectable URL address included in the communication message will cause browser 216 to submit a Hypertext Transfer Protocol (HTTP) request to a server/system of the service provider system 230. In some embodiments the link will direct the browser 216 to the secure transaction processing system 252. The user is able to securely purchase credits from the secure transaction processing system 252 via the browser at 316. Specifically, a user is able to purchase credits directly from the service provider 230 and not through the app distribution platform 144. By purchasing the credits directly through the service provider system 230, the service provider system is advantageously able to avoid the transaction fees required by the app distribution platform 144 associated with in-app purchases. In addition, users can be offered a discount for purchasing credits directly through the service provider system 230. In some embodiments, the website of the secure transaction processing system 252 may be a secure website using the Hypertext Transfer Protocol Secure (HTTPS) protocol. The secure transaction processing system 252 will identify the appropriate user account in user account database 250 and update the user account balance accordingly for any purchases made by the user. In some embodiments, at 318 the secure transaction processing system will not only update the user account balance, but will also update a parameter in the user's account indicating they are a “direct payment user” (i.e., the user purchased credits directly from service provider rather than through in-app purchases of credits through the mobile app 220.) In some embodiments, the secure transaction processing system 252 will send payment information, an indication of the user account, and an indication of a purchased amount to the account services system 232 which will then identify the appropriate user account in user account database 250, and update the user account balance accordingly using the purchased amount received. In some embodiments, at 320 a confirmation message confirming the user's purchase of credits is sent to end-user device 202. The confirmation message may be an order confirmation sent to browser 216 or an email/SMS sent to messaging system 214.

At 322, the user may launch the application on end-user device 202 to access services of the service provider system 230 to access their account information. The account services system 232 will obtain account balance information from user account database 250 at step 324. At 326, the user account database 250 will provide the requested information which is then sent as updated balance information to be displayed in mobile app 220 at 328. In some embodiments, the mobile app 220 may receive a notification in the form of an Internet Protocol (IP) or User Datagram Protocol (UDP) message including the updated balance amount from the service provider system 230 while mobile app 220 is running in the background (i.e., does not need to be launched to obtain the updated balance). In some embodiments, a “badge” or other notification may be displayed on and user device 202, or within mobile app 220, indicating the updated balance. He badge or notification may be shown until the user performs a function such as completing and off net call for viewing the balance from within the mobile app 220.

At 330, the user is then able to access paid services using the purchase credits via the mobile app 220.

In some embodiments, once a user becomes a direct payment user, some display screens in mobile app 220 may change. In some non-limiting examples, once a user becomes a direct payment user, the standard store page which facilitates in app purchases of credits may not be displayed. In some embodiments, the standard store page may be replaced by a screen including a link to the secure transaction processing system 252, that when selected, opens up browser 216 so the user may be able to purchase additional credits. In some embodiments, the user may be able to access their account settings in the account services system 232 to unsubscribe as a direct payment user. When a user unsubscribes as a direct payment user, the standard store page allowing in-app purchases will be displayed again.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

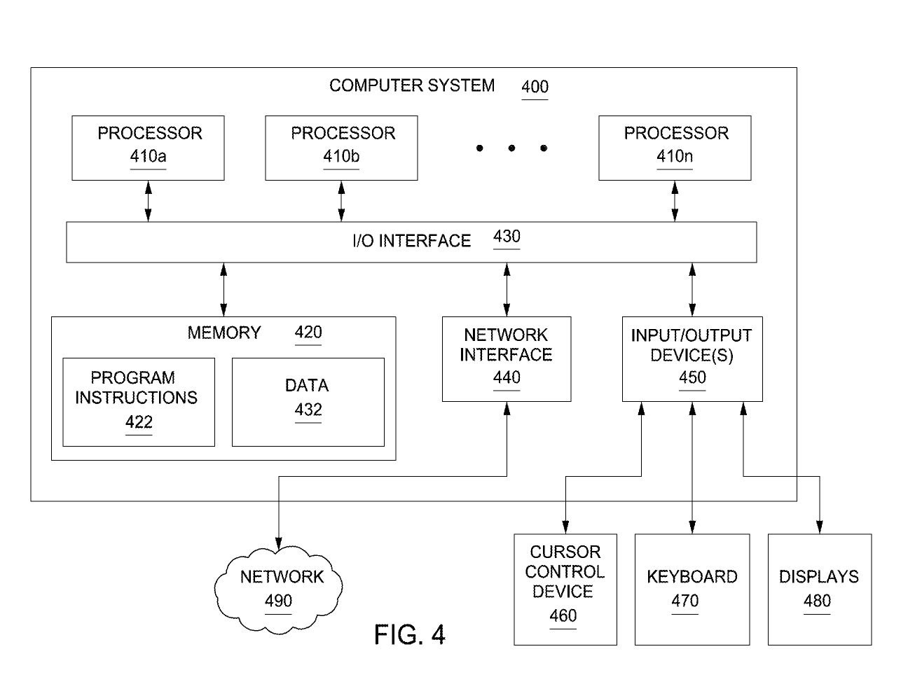

FIG. 4 depicts a computer system 400 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement methods described above. The computer system 400 may be used to implement any other system, device, element, functionality or method of the above-described embodiments. In the illustrated embodiments, computer system 400 may be configured to implement method 300 as processor-executable executable program instructions 422 (e.g., program instructions executable by processor(s) 410) in various embodiments.

In the illustrated embodiment, computer system 400 includes one or more processors 410a-410n coupled to a system memory 420 via an input/output (I/O) interface 430. Computer system 400 further includes a network interface 440 coupled to I/O interface 430, and one or more input/output devices 450, such as cursor control device 460, keyboard 470, and display(s) 480. In various embodiments, any of the components may be utilized by the system to receive user input described above. In various embodiments, a user interface may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410 may be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the methods described above, such as the methods illustrated by the flowchart of FIG. 3. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer-implemented method for identifying and updating service account information on a service provider system, comprising:
receiving a first request to register a user account from a mobile app installed on a user device, wherein the first request includes a unique communication identifier;
sending a communication message directed to the unique communication identifier including a uniform resource locator (URL) address of a website;
receiving, via the website, payment information, an indication of the user account, and an indication of a purchased amount; and
updating account balance information associated with the user account based on the indication of the purchased amount.

2. The computer-implemented method of claim 1, wherein the communication message is one of an email message, an Short Message Service (SMS) message, or a Multimedia Messaging Service (MMS) message.

3. The computer-implemented method of claim 1, wherein the communication message sent is triggered by a successful registration of the user account.

4. The computer-implemented method of claim 1, wherein the communication message sent is triggered when an account balance is below a predefined threshold.

5. The computer-implemented method of claim 1, wherein the URL address in the communication message sent includes user account information.

6. The computer-implemented method of claim 5, wherein the user account information is obtained from the first request.

7. The computer-implemented method of claim 5, wherein the user account information was stored in a database associated with the user account before the first request is received.

8. The computer-implemented method of claim 5, the method further comprising:
receiving a second request for the website at the URL address from the user device; and
sending the requested website to the user device pre-populated with at least some of the user account information.

9. The computer-implemented method of claim 1, wherein the method further comprises sending the updated account balance information to the first device.

10. The computer-implemented method of claim 1, wherein the communication message is sent to the first device.

11. The computer-implemented method of claim 1, further comprising:
receiving a request to access paid services from the mobile app;
providing access to the paid services by the mobile app; and
deducting an amount from the account balance associated with the mobile app for the paid services accessed by the mobile app.

12. The computer-implemented method of claim 1, wherein the unique communication identifier is one of a phone number or an email address.

13. The computer-implemented method of claim 1, wherein the mobile app is a Voice over Internet Protocol (VoIP) telecommunication app, and the purchased amount can be used for paid VoIP telecommunication services.

14. A computer-implemented method for registering a mobile app and obtaining mobile app credits, comprising:
downloading the mobile app from a first entity;
sending a first request to register a user account associated with the mobile app to a second entity, wherein the request includes a unique communication identifier;
receiving, responsive to the first request sent, a communication message directed to the unique communication identifier including a uniform resource locator (URL) address of a website; and
displaying the website in a browser application responsive to receiving a selection of the URL address; and
submitting, via the browser, payment information, an indication of the user account, and a purchase amount for use with the mobile app.

15. The computer-implemented method of claim 14, wherein the URL address in the communication message received includes user account information.

16. The computer-implemented method of claim 15, wherein the user account information is obtained from at least one of the communication message received or the mobile app.

17. The computer-implemented method of claim 15, wherein the website displayed is pre-populated with at least some of the user account information.

18. The computer-implemented method of claim 14, wherein the method further comprises receiving updated account balance information.

19. The computer-implemented method of claim 14, wherein the mobile app is a Voice over Internet Protocol (VoIP) telecommunication app, and the mobile app credits can be used for paid VoIP telecommunication services.

20. The computer-implemented method of claim 19, wherein the second entity is a VoIP telecommunication service provider.

21. A system for identifying and updating service account information on a service provider system, comprising:
a user account database that stores user account information;
an account services system including at least one processor comprising:
a registration module configured to receive a first request to register a user account from a mobile app installed on a user device, wherein the first request includes a unique communication identifier; and
an account balance monitor module configured to send a communication message directed to the unique communication identifier including a uniform resource locator (URL) address of a secure transaction processing system website; and
the secure transaction processing system including a website configured to:
receive payment information, and indication of the user account, and a purchase amount; and
update account balance information associated with the user account based on the indication of the purchased amount.

22. The system of claim 21, wherein the communication message is one of an email message, a Short Message Service (SMS) message, or a Multimedia Messaging Service (MMS) message.

23. The system of claim 21, wherein the account balance monitor module is configured to send the communication message upon a successful registration of the user account.

24. The system of claim 21, wherein the account balance monitor module is configured to send the communication message when an account balance is below a predefined threshold.

25. The system of claim 21, wherein the URL address in the communication message sent includes user account information.

26. The system of claim 25, wherein the user account information is obtained from the first request.

27. The system of claim 25, wherein the user account information was stored in a database associated with the user account before the first request is received.

28. The system of claim 21, wherein the unique communication identifier is one of a phone number or an email address.
